(19) United States
(12) Patent Application Publication
(10) Pub. No.: US 2015/0318138 A1
(43) Pub. Date: Nov. 5, 2015

(54) CHARGED PARTICLE BEAM TARGETS

(71) Applicant: ISIS INNOVATION LIMITED, Oxford Oxfordshire (GB)

(72) Inventor: Ivan KONOPLEV, Oxford (GB)

(21) Appl. No.: 14/651,693

(22) PCT Filed: Nov. 25, 2013
(86) PCT No.: PCT/GB2013/053101

§ 371 Date: Jun. 12, 2015

(30) Foreign Application Priority Data
Dec. 12, 2012 (GB) 1222363.2

(51) Int. Cl. H01J 35/26; H01J 35/10

(52) U.S. Cl. CPC H01J 35/26; H01J 35/105; H01J 2235/1245; H01J 2235/1204

(57) ABSTRACT

An apparatus comprises a charged particle beam source and a target (1) for a charged particle beam. The target comprises a concave outer surface which is at least a segment of a cylinder (2) having a periodically structured surface (4). The charged particle beam is directed parallel to the axis of the cylinder (2), with the distance of the charged particle beam from the surface being less than or equal to twice the period of the periodically structured surface (4) in a direction perpendicular to the charged particle beam. The width of the charged particle beam in a direction perpendicular to the charged particle beam and parallel to the outer surface of the target is less than twice the period of the periodically structured surface (4) in a direction perpendicular to the charged particle beam.

This invention relates to targets for charged particle beams, in particular targets which are used in X-ray generators or charged particle dumps.

X-ray generators are conventionally arranged with a small linear accelerator which accelerates electrons from a cathode to an anode target which the electrons strike. The impact of the electrons creates a very intense hot spot on the target and causes the target to emit X-rays in all directions. In order to direct the X-rays to be used elsewhere a collimator is used, resulting in only a small fraction of the X-rays being usefully exploited. Furthermore, it is difficult to control the size of the hot spot on the target and the energy of the X-rays produced, and as the majority of the energy of the beam goes into the heating of the target, cooling is needed to regulate the temperature of the target. The only variables available to the user are the type of target and the energy of the electron beam, neither of which can be varied very quickly, and so it is difficult to obtain multiple different wavelengths of X-rays simultaneously.

Similarly, a beam dump for charged particles in a particle accelerator conventionally comprises a target placed in the path of the charged particle beam. When the charged particle beam is required to be dumped, the beam is deflected onto the target where it is absorbed. As with conventional X-ray generators, this creates a very intense hot spot on the target and a large amount of associated ionising radiation. As a result, lots of cooling and shielding for the target needs to be provided to run a safe beam dump.

It is an aim of the present invention to provide an improved target for a charged particle beam.

When viewed from a first aspect the invention provides an apparatus comprising a charged particle beam source and a target for a charged particle beam, the target comprising a concave outer surface, the concave outer surface comprising at least a segment of a cylinder with a periodically structured surface, wherein the charged particle beam is directed parallel to the axis of the cylinder, the distance of the charged particle beam from the surface is less than or equal to twice the period of the periodically structured surface in a direction perpendicular to the charged particle beam, and the width of the charged particle beam in a direction perpendicular to the charged particle beam and parallel to the outer surface of the target is less than twice the period of the periodically structured surface in a direction perpendicular to the charged particle beam.

When viewed from a second aspect the invention provides a method of allowing a charged particle beam to strike a target, the target comprising a concave outer surface, the concave outer surface comprising at least a segment of a cylinder with a periodically structured surface, the method comprising:

generating the charged particle beam having a width, in a direction perpendicular to the charged particle beam and parallel to the outer surface of the target, less than twice the period of the periodically structured surface in a direction perpendicular to the charged particle beam;

and directing the charged particle beam parallel to the axis of the cylinder at a distance from the surface less than or equal to twice the period of the periodically structured surface in a direction perpendicular to the charged particle beam.

The invention also extends to an X-ray generator comprising the apparatus, to a charged particle beam dump comprising the apparatus, and to a target adapted for use in the apparatus. The “width” of the charged particle beam is defined as the width in which 95% of the particles in the charged particles are located.

Providing a localised charged particle beam close to a periodically structured surface on a concave outer surface results in the charged particle beam being spread out in a radial direction owing to the ponderomotive force. The ponderomotive force is a nonlinear force that a charged particle experiences in an inhomogeneous oscillating electromagnetic field. The ponderomotive force Fₚ in the case of relativistic charged particles is expressed by

$${F}_{p} = - ▽ U ( r ) = - ▽ ( \frac{{q}^{2} {E}^{2} ( r )}{4 m {γω}^{2}} )$$

where q is the electrical charge of the particle, m is the mass, ω is the angular frequency of oscillation of the field, and E is the amplitude of the electric field. This equation means that a charged particle in an inhomogeneous oscillating field not only oscillates at the frequency of ω but also drifts toward the weak field area.

The ponderomotive force is generated and acts on the charged particle beam because of the varying relative permittivity of the periodically structured surface experienced by the charged particle beam which creates an inhomogeneous oscillating electric field. The charged particles therefore move from the higher intensity field to the lower intensity field. The oscillating electromagnetic field has a local maximum at a distance from the periodically structured surface approximately equal to the period of the structure. Thus if the beam is located closer to the surface than this distance the ponderomotive force causes the charged particles to strike the concave outer surface of the target, with the impact generating X-rays.

Charged particles with a higher energy will be deflected less by the ponderomotive force and therefore travel further before striking the concave outer surface of the target. The spread of energies in the charged particle beam will be accentuated as the beam passes alongside the periodically structured surface and the ponderomotive force acts on the beam because the work done by the oscillating electromagnetic field extracts energy from the beam. As the energy of the X-rays generated by the impact of the charged particles depends on the energy of the charged particles, and the impact site of the charged particles depends on their energy, this allows an X-ray generator to be produced in which X-rays of different energies are produced simultaneously with the different energy X-rays being spatially separated. For example the X-rays may be generated by an electron beam having electron energies between 1 and 10 MeV e.g. from 3 MeV to 9 MeV (initial energy of 6 MeV) which would give rise to the simultaneous production of a spatially spread series of X-rays with different corresponding energies. Thus different energy X-rays can be selected easily without having to vary the energy to which the charged particle beam is accelerated, as has to be done with current X-ray generators. This is of great advantage in an X-ray generator as it creates a very versatile X-ray source, for example at border checkpoints where vehicles are scanned using X-rays. The different wavelengths produced by such an X-ray source allows different materials to be identified easily because of the different absorption spectra of different materials.

If the particle beam, or part of it, is located radially inwardly of the local electromagnetic field maximum the particles will experience a radial ponderomotive force towards the central axis of the cylinder. In such embodiments the target further comprises a tapered strike surface which tapers towards the central axis so that particles travelling at different radial distances from the central axis will strike it at different points. This has the same effect of spatially distributing the energies of the X-rays generated as is achieved when the particles strike the contoured surface. Of course the beam may be arranged to straddle the local maximum of the ponderomotive force so that some particles strike the contoured surface and some strike the tapered strike surface. The ponderomotive force is too weak to have a significant effect at a distance from the structured surface of more than twice the period of the structure.

This is novel and inventive in its own right and therefore when viewed from a further aspect the invention provides a target for a charged particle beam, the target comprising a concave outer surface, the concave outer surface comprising at least a segment of a cylinder with a periodically structured surface and a tapered strike surface for receiving a charged particle beam tapering towards the axis of the cylinder.

The present invention is also advantageous for use in a beam dump for a charged particle beam for similar reasons. Because the impact of the charged particles is distributed across the curved outer surface of the target or across the tapered strike surface (according to the energy of the charged particles), the intensity of the impact is much reduced compared to a conventional beam dump in which a target is simply placed in the path of the charge particle beam, thus creating a very intense hot spot on the target. As a result, much less ionising radiation is produced and so the cladding and shielding needed behind the target can be reduced, as can the amount of radiation protection and cooling needed. This creates a much cheaper and safer overall structure.

As will also be appreciated, the target of the present invention is a passive structure, requiring no external energy input because the inhomogeneous oscillating electric field which generates the ponderomotive force simply comes from the interaction of the charged particle beam with the periodically structured surface or the tapered strike surface. Thus the target is inexpensive and easy to run and maintain, as well as being simple to install into a current system. For example, for installation as a charged particle beam dump, the target just needs to be placed at an appropriate location at the end of a particle accelerator.

In one set of embodiments the concave outer surface comprises a channel extending in a direction parallel to the axis of the cylinder, wherein the channel is located in the part of the concave outer surface closest to the charged particle beam.

Where the beam is located such that at least some of the particles strike the contoured surface the channel provides a location for the impact of the charged particle beam such that the damage created on impact is controllable and does not interfere with the remaining portion of the charged particle beam which has yet to strike the target. Furthermore, the channel may be arranged to be replaceable within the concave outer surface of the target so that it can be easily replaced once it has been damaged after one or more impacts from the charged particle beam.

In one set of embodiments the channel and/or the tapered strike surface comprises a different material to the concave outer surface, i.e. it does not necessarily have a structure of its own. Providing a different material for the channel or tapered strike surface allows the material to be more suitable for the impact of a charged particle beam compared to the concave outer surface which can be made from a material which is more suited to manufacturing the periodically structured surface, for example. The materials could have properties which, for example, are suitable for the absorption of charged particles, if the target is part of a beam dump, or are suitable for the generation of X-rays, if the target is part of an X-ray generator. In the latter example, the channel material could vary along the length of the channel, such that it is suitable for generating X-rays of different energies at the different locations for the impact of different energy charged particles. The material could comprise a refractory metal—i.e. a metal with a high melting point such as molybdenum of tungsten. However less temperature resistant and less costly materials such as aluminium, copper, iron as well as their alloys can also be used. The material could homogenous or could comprise a layer on another base material.

In another set of embodiments, not necessarily mutually exclusive with the channel comprising a different material to the concave outer surface, the channel could project from the concave outer surface, but preferably the channel is recessed in the concave outer surface. This makes it easier to contain the debris from the impact of the charged particle beam within the channel such that it does not interfere with the remainder of the charged particle beam. The channel is not necessarily recessed relative to all of the periodically structured surface. For example, the channel could be recessed compared to the projecting parts of the periodically structured surface and flush with, or even projecting from, its recessed parts. However in one set of embodiments the channel is recessed with respect to substantially all of the periodically structured surface.

Even when the channel has its own structure it may also comprise a different material to the concave outer surface. The different material may be provided only within the channel itself, e.g. on its base and/or up its side walls, or the different material may extend into the concave outer surface. The channel could take any convenient shape, e.g. have a rectangular or curved cross-section, and in a preferred set of embodiments the dimensions of the cross-section of the channel are smaller than the period of the periodically structured surface in a direction perpendicular to the axis of the cylinder, i.e. perpendicular to the direction of the channel. In one example the channel has a width between 0.1 mm and 2 mm, e.g. 0.5 mm, and/or a depth between 0.1 mm and 2 mm, e.g. 0.5 mm.

The target could comprise any suitable material, for example the material could comprise a refractory metal—i.e. a metal with a high melting point such as molybdenum of tungsten. However less temperature resistant and less costly materials such as aluminium, copper, iron as well as their alloys can also be used. The material could homogenous or could comprise a layer on another base material. The target, to minimise its cost and weight, can also be made from dielectric with metalized surface (the metalized surface ensures the formation of ponderomotive potential of a required transverse profile). The concave outer surface and/or the tapered strike surface of the target could comprise a different material to the rest of the target. For example, the concave outer surface and/or the tapered strike surface could comprise a material suitable for absorbing the impact of the charged particle beam, generating X-rays and/or generating the ponderomotive force, and the rest of the target could comprise a material suitable for giving the target a strong structure. In one set of embodiments the target, e.g. the concave outer surface thereof, comprises a dielectric.

The periodically structured surface could comprise many different shapes, e.g. sinusoidal or rectangular. Preferably the period of the periodically structured surface in the direction perpendicular to the axis of the cylinder, i.e. in an azimuthal direction, is greater than the period in the direction parallel to the axis of the cylinder (the longitudinal period). For example, the azimuthal period may be between 2 mm and 10 mm, e.g. 4 mm, and the longitudinal period may be between 0.2 mm and 2 mm, e.g. 0.4 mm. Alternatively the azimuthal period may be measured in terms of its angular period, e.g. between π/10 radians and π/2 radians, e.g. π/3 radians, owing to the curvature of the periodically structured surface in this direction.

There is a correlation between the energy distribution of the electrons on the target and the period of the periodically structured surface as is clear from the ponderomotive force formula in which the frequency of the electromagnetic EM field ω is proportional to 2π/d where d is the period of the surface along the particle motion. Thus for a high energy beam a longer period structure would be preferable. So if, for instance, the total length of the structure over which the particle dumping should take place is predefined, the parameter γ/d² should be kept constant. Also the length of the structure is proportional to the product of the period and the number of repetitions. For example the period for an electron beam of energy 5 MeV and 10 MeV (e.g. 7 MeV) could be 0.1 mm and 2 mm e.g. 0.5 mm for a specific beam charge. Thus the period can be varied in order to enable targets of different lengths to be provided.

In one set of embodiments the periodically structured surface has a longitudinal cross-section which has a square wave shape, i.e. parallel to the axis of the cylinder. In another set of embodiments, the periodically structured surface has a cross-section which has a square wave shape in a direction perpendicular to the axis of the cylinder, if the concave outer surface were to be rolled out flat. Therefore in a preferred set of embodiments the periodically structured surface can be thought of as having a chequered pattern, alternate rectangles recessed and projecting, though as detailed above, the relative periods of the square waves may not be equal. The square-wave chequered pattern is relatively straightforward to manufacture as grooves can be machined on the inner surface of the cylinder parallel to the axis of the cylinder. The cylinder can then be cut into sections perpendicular to its axis, with alternate sections being rotated by half a period to create the chequered pattern. The squares/rectangles could have sharp or rounded/truncated corners. Moreover it should be appreciated that all such shapes are merely exemplary and other shapes such as trapezoidal, sinusoidal etc. could be used instead.

In a set of embodiments the depth of the periodically structured surface, i.e. the distance between the most recessed parts and the most projecting parts, is less than the period of the periodically structured surface in the longitudinal and/or azimuthal directions. This is believed to give the greatest efficiency and ease of manufacture but is not essential. The ideal depth may differ depending on the longitudinal period. The depth of corrugations may be less than d/4 where d is the period of the corrugation along the particle motion. For example, where the longitudinal period is between 0.2 mm and 2 mm the depth of the periodically structured surface may be between 0.05 mm and 0.5 mm, e.g. 0.2 mm. However in some cases it could be beneficial to have a larger amplitude of corrugation. Indeed in other embodiments the amplitude of corrugation may be significantly more than the period in either directions and not linked to either period.

In general the width containing 95% of the particles in the charged particle beam in a direction perpendicular to the charged particle beam and parallel to the outer surface of the target is less than the period of the periodically structured surface in a direction perpendicular to the charged particle beam, i.e. the size of the particle beam is small compared to the dimensions of the periodically structured surface along this dimension. The cross-section of the charged particle beam could take any convenient shape, e.g. circular, elliptical. In one set of embodiments the cross-sectional shape of the charged particle beam is an annular segment, e.g. parallel to the concave outer surface. In one example the azimuthal width of the charged particle beam is between 0.5 mm and 5 mm, e.g. 1.5 mm. Alternatively the azimuthal size of the beam may be measured in terms of its angular size, e.g. between π/15 radians and π/3 radians, e.g. π/6 radians, owing to the curvature of the periodically structured surface in this direction.

In general the distance of the centroid of the charged particle beam from the concave outer surface, e.g. from the average position of the surface, is less than or equal to twice the period of the periodically structured surface in a direction perpendicular to the charged particle beam. In a set of embodiments it is within a distance of less than half the period. For example, the charged particle beam may be between 0.1 mm and 2 mm from the concave outer surface, e.g. 0.4 mm. In one set of embodiments the dimensions of at least one of the width of the channel and the depth of the channel is less than the azimuthal width of the charged particle beam.

The charged particle beam could comprise any stable or semi-stable charged particles, e.g. protons, anti-protons, muons, positrons, charged isotopes (for isotope separation), but preferably the charged particle beam comprises an electron beam. An electron beam is particularly useful for creating X-rays. Typically when used in an X-ray generator, an electron beam may have an average energy between 2 MeV and 20 MeV, e.g. 10 MeV. When used in a particle accelerator, an electron beam may have an average energy between anything from a few MeV to several TeV.

The concave outer surface of the target, comprising at least a segment of a cylinder, could take any suitable concave shape. The concave outer surface could be curved with locally straight sections or corners where the gradient of the surface is not continuous. Alternatively the concave outer surface may comprise at least a segment of a cylinder with an elliptical or circular cross-section, i.e. the concave outer surface may be continuously curved.

The target will generally be housed in an evacuated chamber, e.g. a vacuum vessel, to prevent unwanted collisions with the charged particle beam before it strikes the target. The inner wall of the evacuated chamber could comprise the target or the target could be mounted within the evacuated chamber. In either of these cases, the target could be provided all the way round the evacuated chamber, for example all of the inner wall of the evacuated chamber could comprise the periodically structured surface, i.e. the at least a segment of a cylinder is a whole cylinder.

Alternatively the target could be provided only across a certain angular range, e.g. across a portion of the inner wall of the evacuated chamber, with the charged particle beam being directed alongside this portion. For example the target, comprising at least a segment of a cylinder, may subtend an angle of less than π radians from the central axis of the evacuated chamber in a plane perpendicular to the axis, e.g. less than π/2 radians, e.g. less than π/3 radians. This enables a smaller target to be provided, making it cheaper to manufacture, while losing hardly any efficiency as the charged particle beam is mostly affected by the part of the target which it is directed closest to. In this set of embodiments preferably the charged particle beam is directed along a line parallel to the centre of the target in a direction parallel to the axis of the cylinder.

The evacuated vessel could be cylindrical, for example having the same shape, if not necessarily the same size, as the target, e.g. an elliptical or circular cross-section. In one set of embodiments the evacuated vessel has an inner diameter of between 5 mm and 25 mm, e.g. 12 mm. If the concave outer surface of the target only comprises a segment of the cylinder, i.e. its coverage is not over the full perimeter of the evacuated chamber, the inventor has appreciated that it is beneficial to provide a concave surface opposite the target. Thus in one set of embodiments the evacuated vessel comprises a concave reflecting surface comprising a segment of a cylinder positioned opposite the concave outer surface of the target. The concave reflecting surface aids the formation of the inhomogeneous oscillating electric field which generates the ponderomotive force. Although the shape of concave reflecting surface does not need to be the same as the shape of the concave outer surface of the target, preferably the angular extent of the concave reflecting surface is substantially equal to the angular extent of the concave outer surface of the target, e.g. less than π radians from the central axis of the evacuated chamber in a plane perpendicular to the axis, e.g. less than π/2 radians, e.g. less than π/3 radians. Preferably the mirror has a size which is larger than the electron beam along the whole trajectory of the beam.

Certain preferred embodiments of the invention will now be described, by way of example only, with reference to the accompanying drawings in which:

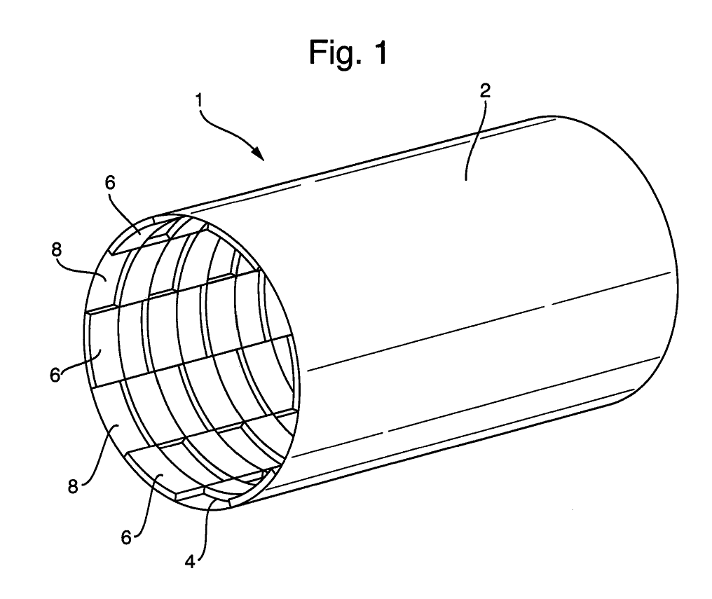

FIG. 1 shows a schematic diagram of a target in accordance with an embodiment of the invention;

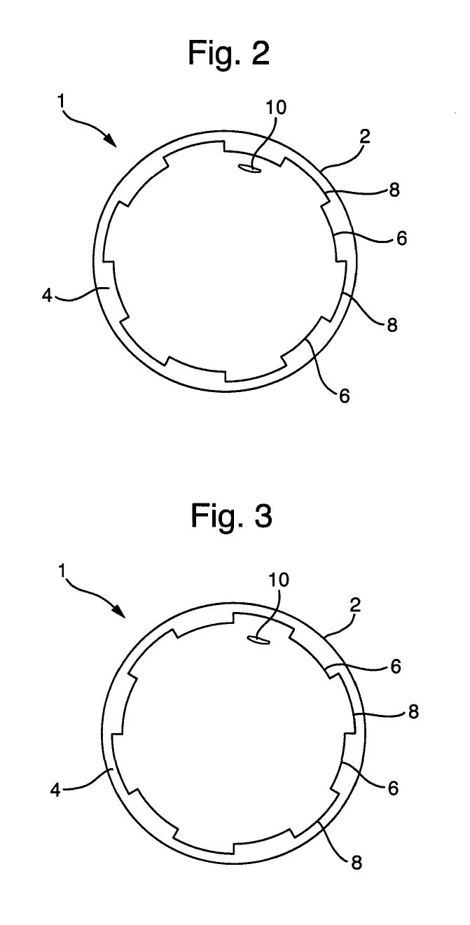

FIGS. 2 and 3 show axial cross-sections through the target shown in FIG. 1;

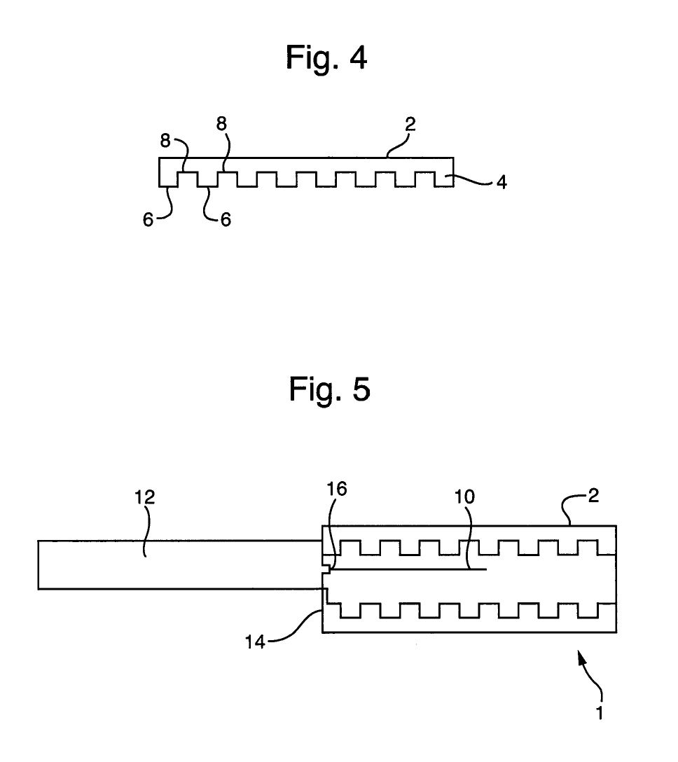

FIG. 4 shows a longitudinal cross-section through the target shown in FIG. 1;

FIG. 5 shows the target arranged in combination with a linear particle accelerator;

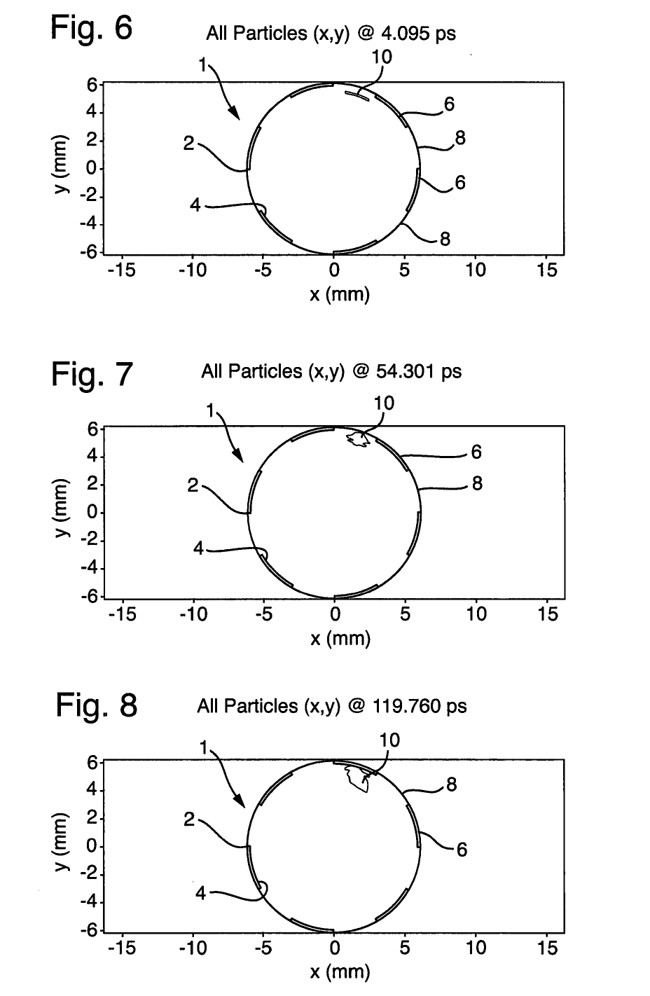

FIGS. 6-10 show simulations of a charged particle beam in operation of the target shown in FIGS. 1-5;

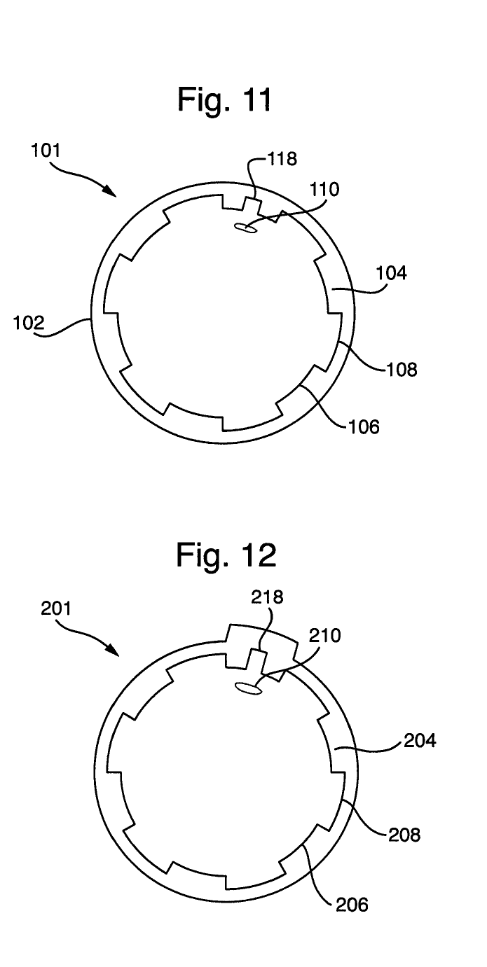

FIG. 11 shows a variation of the embodiment shown in FIGS. 1-5;

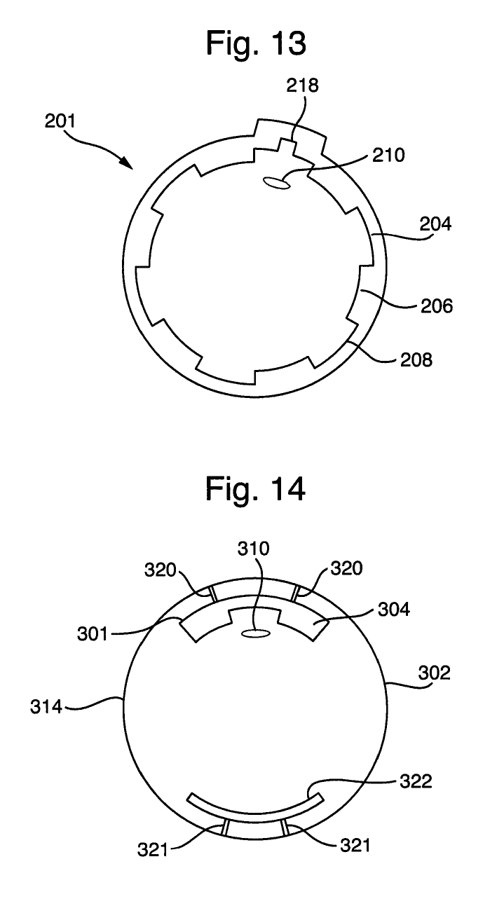

FIGS. 12 and 13 show a further variation of the embodiment shown in FIGS. 1-5; and

FIG. 14 shows a further embodiment of the invention; and

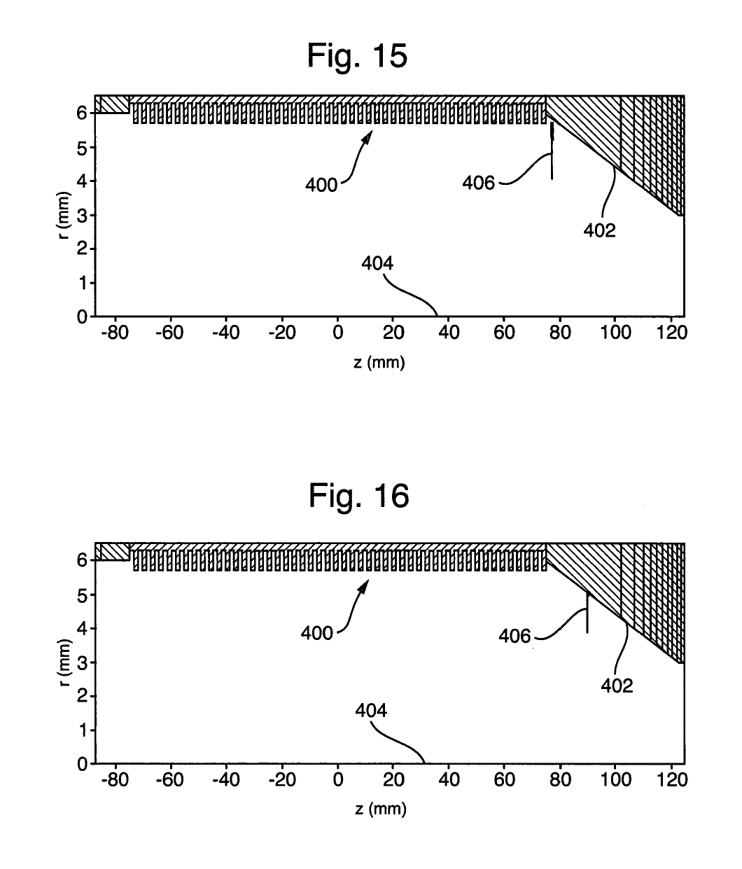

FIGS. 15 and 16 show a target in accordance with another embodiment of the invention with charged particle beam simulations.

FIG. 1 shows a schematic diagram of a perspective view of a target 1 for a charged particle beam in accordance with an embodiment of the invention. The target 1 is a hollow cylinder 2 with a circular cross section. Typically the target will be manufactured from a conductive material e.g. copper and in some cases refractory metals e.g. tin could be more preferable. To minimise the cost and weight of the target it can also be manufactured from any dielectric material with metalized surface (to insure the formation of ponderomotive potential of the required transverse profile). On the inner surface of the hollow cylinder 2 is machined a periodic structure 4. The periodic structure 4 has a chequered pattern with projecting rectangles 6 alternating with recessed rectangles 8 on the inner surface. The detail of the projecting and recessed rectangles 6, 8 can be seen in more detail in FIGS. 2, 3 and 4.

FIGS. 2 and 3 are cross-sectional views of the target 1 shown in FIG. 1, through planes perpendicular to the axis of the cylinder 2. The cross-sections shown in FIGS. 2 and 3 are spaced from each other by half a longitudinal period of the periodic structure 4. Around the inner surface of the hollow cylinder 2, which is approximately 12 mm in diameter, there are six equally sized and shaped projecting rectangles 6 alternating with recessed rectangles 8. The rectangles 6, 8 are approximately 4 mm wide in the azimuthal direction and approximately 0.4 mm wide in the longitudinal direction, with a difference in height of approximately 0.2 mm between the projecting and recessed rectangles 6, 8.

Also shown in FIGS. 2 and 3 is the position of the charged particle beam 10 which collides with the target 1. Typically the charged particle beam 10 is approximately 1.5 mm wide in the azimuthal direction and spaced from the periodic structure by approximately 0.4 mm (from the outer surface of the projecting rectangles 6). FIG. 4 shows a cross-section through the wall of the hollow cylinder 2 in the longitudinal direction showing the profile of the alternating projecting and recessed rectangles 6, 8.

FIG. 5 is a schematic diagram showing the installation of the target 1 at the end of a linear particle accelerator 12, e.g. for use as a beam dump or an X-ray generator. The target forms part of an evacuated vessel 14 which receives, within the hollow cylinder 2, the charged particle beam 10, e.g. 10 MeV electrons, from the linear particle accelerator 12. The target 1 is positioned relative to the linear particle accelerator 12 such that the exit aperture 16 of the linear particle accelerator is offset from the central axis of the hollow cylinder 2, i.e. closer to one side of the inner surface of the hollow cylinder 2 than the opposite side, as is shown in FIGS. 2 and 3.

The operation of the target 1 will now be described with reference to FIGS. 1 to 5 as well as FIGS. 6 to 10 which show simulated snapshots of the charged particle beam 10 at different times following exit of the charged particle beam 10 from the linear particle accelerator 12.

The linear particle accelerator 12 is run to deliver a charged particle beam 10 into the evacuated vessel 14 housing the target 1. The charged particle beam 10 is directed parallel to and approximately 0.4 mm from the inner surface of the hollow cylinder 2, as shown in the axial cross-section of FIG. 6 at a time of 4.095 ps after exit of the beam from the linear particle accelerator 12. The charged particle beam 10 passes alongside the alternating projecting and recessed rectangles 6, 8 of the periodic structure 4 on the inner surface of the hollow cylinder 2. The electric field created by the charged particle beam 10 interacts with the periodic structure 4 as it passes alongside, resulting in an inhomogeneous, oscillating electric field which is experienced by the charged particle beam 10. The ponderomotive force, owing to the charged particle beam 10 experiencing this inhomogeneous, oscillating electric field, causes a force to act on the charged particle beam 10 in the direction of the part of the periodic structure 4 on the inner surface of the hollow cylinder 2 to which the charged particle beam 10 is closest.

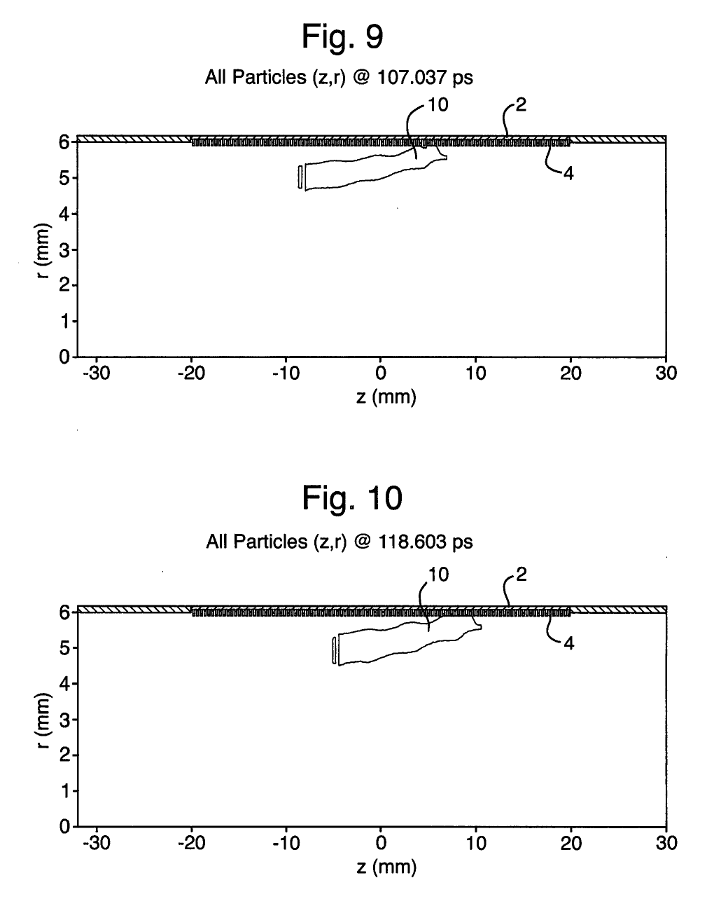

Under the action of the ponderomotive force, the charged particle beam 10 is moved towards the periodic structure 4, as shown in the axial cross-section of FIG. 7 (shown at a time of 54.301 ps), and eventually strikes the periodic structure 4 as shown in the axial cross-section of FIG. 8 (shown at a time of 119.760 ps) and the longitudinal cross-section of FIG. 9 (shown at a time of 107.037 ps). Owing to both the natural spread of energies within the charged particle beam 10 and the energy removed from the charged particle beam 10 owing to the work done by the ponderomotive force which causes a greater spread in energies, the charged particles with the greatest energy travel the furthest along the periodic structure 4 before striking the target 1, as shown in the longitudinal cross-section of FIG. 10 (shown at a time of 118.603 ps) which is the view of a simulation at a time later than FIG. 9. This distributes the impact of the charged particle beam 10 along the target 1 according to the energy of the charge particles.

When the target 1 is used as a beam dump this spread of impacts of the charged particle beam 10 reduces the intensity of the impact at any one point, therefore reducing the amount of ionising radiation produced and requiring less shielding and cooling to be provided for the target 1. When the target 1 is used as an X-ray generator the spread of impacts creates a distributed X-ray source in which the X-rays are distributed along the target longitudinally according to energy, because the impact of higher energy charged particles with the target creates higher energy X-rays and vice versa.

FIG. 11 shows a cross-sectional view of a variation of the embodiment shown in FIGS. 1 to 5 in which a channel 118 is formed running longitudinally through the projecting rectangles 106 of the periodic structure 104, i.e. corresponding to the view shown in FIG. 2. The depth of the channel 118 is such that it only extends into the projecting rectangles 106 and not the recessed rectangles 108 of the periodic structure, so when the cross-section of the target 101 is viewed at a position longitudinally spaced from the cross-sectional view of FIG. 11 by a distance of half the longitudinal period of the periodic structure 104, it looks the same as is shown in FIG. 3 of the previous embodiment.

In the embodiment shown in FIG. 11 the target is arranged relative to the linear particle accelerator in the same manner as shown in FIG. 5, with the charged particle beam 110 being directed along a line offset from the central axis of the hollow cylinder 102, closest to the part of the periodic structure 104 in which is formed the channel 118.

The operation of the embodiment shown in FIG. 11 is very similar to the operation of the embodiment shown in FIGS. 1 to 5. The only difference is that when the charged particle beam 110 strikes the target 101, the impact is centred on the channel 118. This means that any debris created by the impact can be largely contained within the channel 118.

FIGS. 12 and 13 show cross-sectional views of a variation of the embodiment shown in FIG. 11, the cross-sectional views being spaced by half a period of the periodic structure in the longitudinal direction, i.e. as in FIGS. 2 and 3. As in the embodiment shown in FIG. 11, a channel 218 is formed running longitudinally through the periodic structure 204. However in this embodiment the channel 218 is recessed into both the projecting rectangles 206 and the recessed rectangles 208, i.e. deeper than the channel of the embodiment shown in FIG. 11. The operation of the embodiment shown in FIGS. 12 and 13 is almost the same as that of the embodiment shown in FIG. 11, except that the deeper channel 218 is more effective in containing debris created by the impact of the charged particle beam 210 on the target 201.

FIG. 14 shows an axial cross-section of a schematic diagram showing a further embodiment of the invention. In this embodiment the target 301, which extends longitudinally, parallel to the axis of a hollow cylinder 302 which forms an evacuated vessel 314. The arrangement of the evacuated vessel 314, at the end of a linear particle accelerator, is the same as is shown in FIG. 5. The target 301, however, only extends over a limited azimuthal range, about π/3 radians, but is a segment from a cylinder with a circular cross-section. This contrasts with the previous embodiments in which the periodic structure is provided around the whole of the circumference of the inner surface of the hollow cylinder.

A further difference in this embodiment is that the target 301 is mounted by struts 320 within the evacuated vessel 314, i.e. it does not form the inner surface 302 of the evacuated vessel 314. Furthermore, a concave reflecting surface 322 comprising a segment of a cylinder with a circular cross-section over the same azimuthal range as the target 301, and mounted within the evacuated vessel 314 by struts 321, is located diametrically opposite the target 301, which acts as a mirror to the periodic surface 304 ensuring that the inhomogeneous, oscillating electric field which is set up when the charged particle beam 310 passes alongside the periodic surface 304 has its field gradient in the right direction to cause the charged particles to be moved towards the target 301 under the action of the ponderomotive force.

In the embodiment shown in FIG. 14 the target 301 is arranged relative to the linear particle accelerator in the same manner as shown in FIG. 5, with the charged particle beam 310 being directed along a line offset from the central axis of the hollow cylinder 302, closer to the periodic structure 304 on the target 301 than the concave reflecting surface 322. Operation of this embodiment is the same as that for the previous embodiments.

It will be appreciated by those skilled in the art that only a small number of possible embodiments have been described and that many variations and modifications are possible within the scope of the invention. For example the linear accelerator may be simply the evacuated tube of an X-ray generator, i.e. with the periodically structured target replacing the traditional cathode target. The target shown in FIG. 14 could include a channel, as shown in FIGS. 12 and 13, or 14, for example.

FIG. 15 shows another embodiment of the invention. In this embodiment, downstream of the periodically structured surface 400 the target comprises a tapered strike surface 402 which tapers towards the central axis 404. In this embodiment the original particle beam is directed a little further away from the structured surface 400, so that by the time the beam 406 has travelled to the end of the periodic structure it has spread out radially both inwardly towards the axis 404 and outwardly towards the periodic structure 400. However rather than striking the periodic structure or a channel defined therein as in previous embodiments, the spread of the particle beam 406 is such that all of the beam passes beyond the end of the cylindrical portion of the target to strike the tapered surface 402. As will be appreciated the radially outermost particles—i.e. those with the lowest energies which are more influenced by the ponderomotive force will strike the tapered surface 402 first, whereas the more energetic particles travelling along the radially innermost trajectories will strike the tapered surface further along as shown in FIG. 16. This also gives rise to a corresponding spatial distribution of X-rays generated when the particles strike the tapered surface 102 of the target.

1.-46. (canceled)

47. An apparatus comprising a charged particle beam source and a target for a charged particle beam, the target comprising a concave outer surface, the concave outer surface comprising at least a segment of a cylinder with a periodically structured surface, wherein a charged particle beam is directed in a direction parallel to a longitudinal axis of the cylinder, the charged particle beam is distanced from the periodically structured surface by less than or equal to twice a period of the periodically structured surface in a direction perpendicular to the charged particle beam, and the width of the charged particle beam in a direction that is perpendicular to the charged particle beam and that is parallel to the concave outer surface of the target is less than twice the period of the periodically structured surface in the direction perpendicular to the charged particle beam.

48. The apparatus as claimed in claim 47 wherein the concave outer surface comprises a channel extending in a direction parallel to the longitudinal axis of the cylinder, wherein the channel is located in a part of the concave outer surface closest to the charged particle beam.

49. The apparatus as claimed in claim 48 wherein the channel is recessed in the concave outer surface.

50. The apparatus as claimed in claim 49 wherein the channel is recessed with respect to substantially all of the periodically structured surface.

51. The apparatus as claimed in claim 48 wherein cross-sectional dimensions of the channel are smaller than the period of the periodically structured surface in a direction perpendicular to the longitudinal axis of the cylinder.

52. The apparatus as claimed in claim 48 wherein at least one of a width of the channel and a depth of the channel is less than an azimuthal width of the charged particle beam.

53. The apparatus as claimed in claim 47 wherein the target further comprises a tapered strike surface that tapers toward a central axis of the target.

54. The apparatus as claimed in claim 53 wherein the channel or the strike surface comprises a material that differs from a material of the concave outer surface.

55. The apparatus as claimed in claim 47 wherein the target comprises a dielectric with a metalized surface.

56. The apparatus as claimed in claim 47 wherein a period of the periodically structured surface in the direction perpendicular to the longitudinal axis of the cylinder is greater than a period of the periodically structured surface in the direction parallel to the longitudinal axis of the cylinder.

57. The apparatus as claimed in claim 47 wherein the periodically structured surface has a longitudinal cross-section that has a square wave shape.

58. The apparatus as claimed in claim 47 wherein the periodically structured surface has a cross-section that has a square wave shape in a direction perpendicular to the longitudinal axis of the cylinder.

59. The apparatus as claimed in claim 47 wherein a depth of the periodically structured surface is less than at least one of the period of the periodically structured surface in a longitudinal direction and a period of the periodically structured surface in an azimuthal direction.

60. The apparatus as claimed in claim 47 wherein a width containing 95% of the particles in the charged particle beam in the direction perpendicular to the charged particle beam and parallel to the concave outer surface of the target is less than the period of the periodically structured surface in the direction perpendicular to the charged particle beam.

61. The apparatus as claimed in claim 47 wherein a centroid of the charged particle beam is distanced from the concave outer surface by less than the period of the periodically structured surface in a direction perpendicular to the charged particle beam.

62. The apparatus as claimed in claim 47 further comprising an evacuated chamber, wherein the evacuated chamber comprises the target; and wherein the target, comprising at least a segment of a cylinder, subtends an angle of less than π radians from a central axis of the evacuated chamber in a plane perpendicular to the central axis.

63. The apparatus as claimed in claim 62 wherein the charged particle beam is directed along a line parallel to a center of the target in a direction parallel to the central axis of the cylinder.

64. The apparatus as claimed in claim 62 wherein the evacuated chamber comprises a concave reflecting surface comprising a segment of a cylinder positioned opposite the concave outer surface of the target.

65. The apparatus as claimed in claim 64 wherein the concave reflecting surface has a size that is larger than a size of the charged particle beam along an entire trajectory of the charged particle beam.

66. A method of allowing a charged particle beam to strike a target, the target comprising a concave outer surface, the concave outer surface comprising at least a segment of a cylinder with a periodically structured surface, the method comprising:
generating the charged particle beam having a width, in a direction perpendicular to the charged particle beam and parallel to the concave outer surface of the target, less than twice a period of the periodically structured surface in a direction perpendicular to the charged particle beam; and
directing the charged particle beam parallel to a longitudinal axis of the cylinder at a distance from the periodically structured surface that is less than or equal to twice the period of the periodically structured surface in the direction perpendicular to the charged particle beam.
